(19) United States
(12) Patent Application Publication
(10) Pub. No.: US 2011/0083701 A1
(43) Pub. Date: Apr. 14, 2011

(54) PROCESS TO CLEAN GAS TURBINE FUEL CHAMBER COMPONENTS

(75) Inventors: Mel Joseph Esmacher, Shenandoah, TX (US); James Lee Standard, Alvin, TX (US); Roy Nelson Mckean, Conroe, TX (US); Martin John Spalding, Atlanta, GA (US); Eric Thomas Hendrickson, Spring, TX (US)

(73) Assignee: GENERAL ELECTRIC COMPANY, Schenectady, NY (US)

(21) Appl. No.: 12/576,517

(22) Filed: Oct. 9, 2009

(51) Int. Cl. B08B 9/027

(52) U.S. Cl. 134/22.11

(57) ABSTRACT

A method for conveying a chemical solution containing a phosphonic acid as an iron dissolving agent through the quaternary annulus chambers in forward combustion cans of a gas turbine to dissolve the iron oxide deposits and thereby facilitate cleaning of the internal fuel pathways. The method uses a cleaning flange attached to the quaternary fuel flange that has a flow directing baffle that enters the quaternary fuel orifice and directs the flow of cleaning solution in one direction in the quaternary annulus chamber.

### BACKGROUND OF THE INVENTION

1. Field of the Invention

This invention relates generally to removal of iron oxide corrosion products, and more specifically to a process for delivering cleaning chemicals to remove corrosion build up that may form inside fuel pathways in gas turbines.

2. Description of Related Art

Certain gas turbines, such as GE Frame 6FA, 7FA, and 9FA gas turbines, have components that are constructed of mild steel. Iron oxide corrosion products may form and cause an undesirable build-up of iron deposits inside fuel pathways or channels of the turbine combustion casings, or “cans”. For example, FIGS. 1 and 2 schematically illustrate a GE gas turbine forward combustion can having a quaternary fuel circuit. A quaternary fuel gas inlet orifice leads to a quaternary fuel gas distribution annulus chamber extending around the circumference of the forward combustion can. The fuel gas in the quaternary annulus chamber is distributed by multiple quaternary pegs (e.g., 15 pegs) into the forward combustion chamber. Any iron oxide corrosion products that collect in the quaternary annulus chamber may result in blockage of the fuel gas passages in the quaternary pegs, which potentially interferes with the flame pattern in the combustion chamber. This blockage can lead to reduced efficiencies and increased nitrogen oxide emissions. Additionally, some sites experience trips when activating the quaternary fuel circuit. When inspection of the forward casing indicates iron deposit build-up, cleaning of the quaternary annulus is recommended to insure reliable operation. As can be appreciated, the quaternary fuel gas distribution annulus chamber is a narrow passageway and is difficult to access.

At present, the method of mechanically cleaning the quaternary fuel gas distribution annulus chamber involves cutting off the fuel pegs followed by attempts to hydro-blast the iron deposits by gaining access to the quaternary annulus channel via the fuel peg holes. This can only be done off-site at a facility equipped to cut and reattach the fuel pegs. In part due to the fuel peg removal and re-welding, the cleaning process is very time consuming and typically takes several weeks to process and restore the combustion chamber.

It would be desirable to provide a rapid method to clean critical fuel pathways in a gas turbine thus removing the potential for iron deposits to block fuel gas passages.

### SUMMARY OF THE INVENTION

In one aspect, the invention is directed to a method for conveying a chemical solution through the quaternary fuel gas distribution annulus chamber to dissolve the iron oxide deposits and thereby facilitate cleaning of the internal fuel pathways. In one embodiment, the method cleans iron oxide corrosion deposits that have accumulated in quaternary fuel gas distribution annulus chambers in forward combustion cans of a gas turbine, wherein each forward combustion can has a quaternary fuel flange and a quaternary fuel orifice leading to the quaternary annulus chamber. The method includes removing at least one forward combustion can from the gas turbine and attaching a cleaning flange to the quaternary fuel flange of the can. The cleaning flange has a flow directing baffle that enters the quaternary fuel orifice and extends the length of a throat leading from the quaternary fuel flange to the quaternary annulus chamber such that the baffle divides the throat into a cleaning solution inlet portion and a cleaning solution outlet portion. The method also includes connecting the combustion can to a chemical cleaning system having a chemical supply reservoir that functions as a sump for the cleaning solution and a circulating pump taking suction from the supply reservoir. The chemical cleaning system uses a cleaning solution having a composition containing an iron dissolving agent. The method further includes directing the flow of cleaning solution through quaternary fuel flange using the cleaning flange and through the inlet portion of the throat such that the baffle directs the cleaning solution flow in one direction in the quaternary annulus chamber around the circumference of the combustion can, wherein upon navigating around the quaternary annulus chamber, the baffle directs the cleaning solution into the outlet portion of the throat and out of the combustion can through the cleaning flange. Finally, the method includes returning the cleaning solution to the chemical supply reservoir.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 illustrates a forward combustion can a GE gas turbine;

FIG. 2 illustrates an enlarged cut away view of the forward combustion can of FIG. 1 illustrating the quaternary fuel gas distribution annulus chamber;

FIG. 3 is a schematic view of a chemical cleaning system according to an embodiment of the invention used to clean the quaternary fuel gas distribution annulus chamber of FIG. 2;

FIG. 4 is an enlarged view of a portion of the chemical cleaning system illustrating a cleaning flange of the system connected to a quaternary fuel flange of the forward combustion can; and

FIG. 5 is a perspective view of the cleaning flange of FIG. 4.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

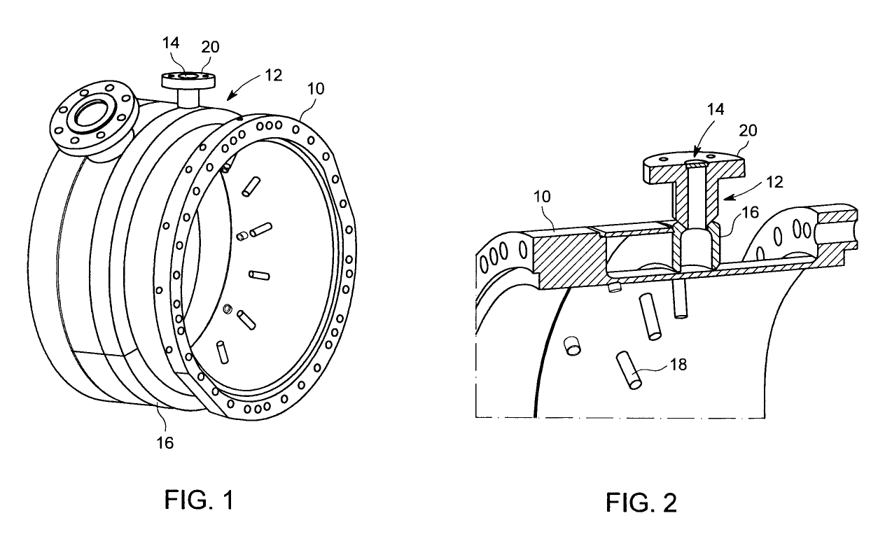

FIGS. 1 and 2 illustrate a forward combustion can 10, of the type used in gas turbines such as GE Frame 6FA, 7FA, and 9FA gas turbines. A typical gas turbine has several, such as 14, forward combustion cans 10. The forward combustion can 10 has a quaternary fuel circuit 12 with a quaternary fuel gas inlet orifice 14 leading to a quaternary fuel gas distribution annulus chamber 16 extending around the circumference of the forward combustion can 10. The fuel gas in the quaternary annulus chamber 16 is distributed by multiple quaternary pegs 18 into the combustion chamber of the forward combustion can 10. The structure of the forward combustion can 10 and the quaternary annulus chamber 16 will be understood by those skilled in the art and need not be discussed in further detail herein.

It is known that iron oxide corrosion products collect in the quaternary annulus chamber 16 and may result in blockage of fuel gas passages in the quaternary pegs 18. This potentially interferes with the flame pattern in the combustion chamber of the forward combustion can 10. The current invention is directed to a method of removing these corrosion products from the quaternary annulus chamber 16 of the forward combustion cans 10. According to the invention, the forward combustion cans 10 are removed from the gas turbine using conventional procedures, and cleaned at a repair facility or on-site with a mobile cleaning unit using a novel procedure such that the cans 10 can be cleaned and placed back on the gas turbine within a matter of a few days rather than the weeks conventional methods required. Although the described embodiment of the invention contemplates removing the forward combustion cans 10 from the turbine, it is to be understood that the cans may be cleaned in place on the turbine without departing from the scope of the invention.

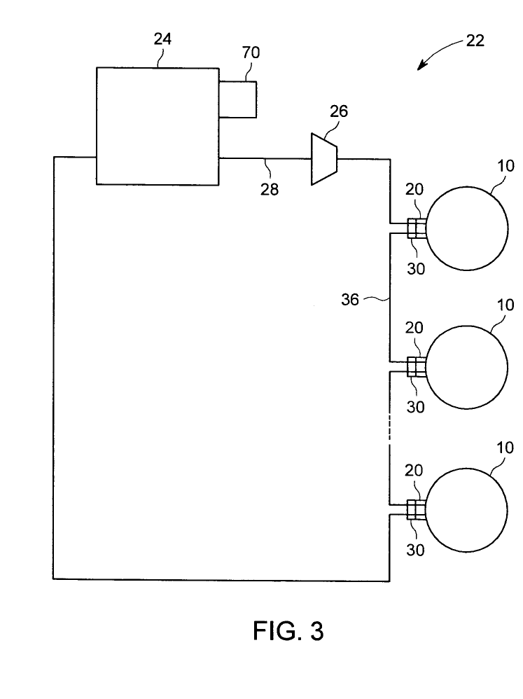

Once the forward combustion cans 10 have been removed from the gas turbine, high pressure air is used to blow out the quaternary annulus chambers 16 of individual cans 10 to remove lose debris. High pressure air is provided to the quaternary annulus chamber 16 by attaching a high pressure air supply (not shown) to the quaternary fuel flange 20 at the quaternary fuel inlet orifice 14. The cans 10 are then connected with a chemical cleaning system 22 as illustrated in FIG. 3. A fresh water flush may initially be used with the chemical cleaning system 22. The chemical cleaning system 22 contains a chemical supply reservoir 24 that functions as a sump for the cleaning solution used in the cleaning process. The supply reservoir 24 desirably has a capacity of at least about 100 gallons and can also be used to mix the cleaning chemicals. A pump 26 in a chemical solution supply line 28 takes suction from the supply reservoir 24 and circulates the chemical solution through the chemical cleaning system 22. In one embodiment, the pump 26 can be a 1½ HP centrifugal pump 26 model no. 2WY27 from W. W. Grainger Inc. of Lake Forrest, Ill. having a capacity of 140 GPM at 2 ft. of head. Flow rates through the chemical cleaning system 22 are desirably between about 20 and about 60 GPM.

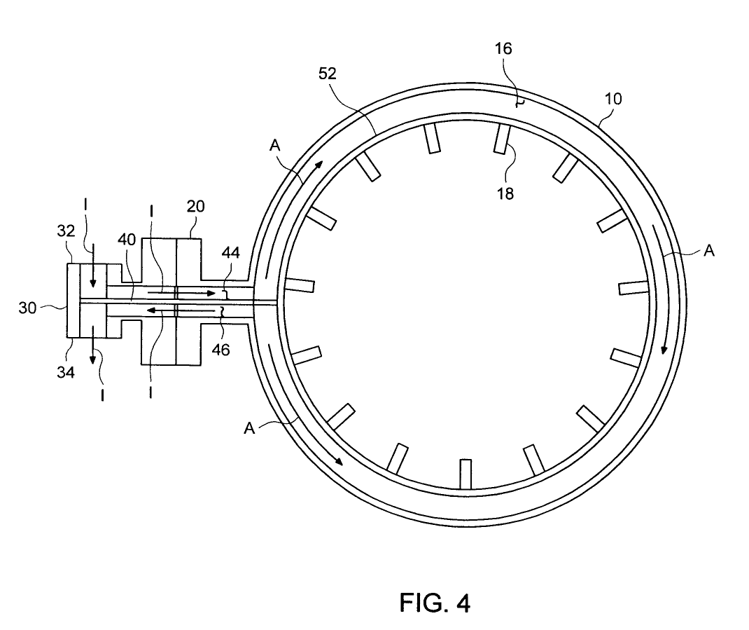

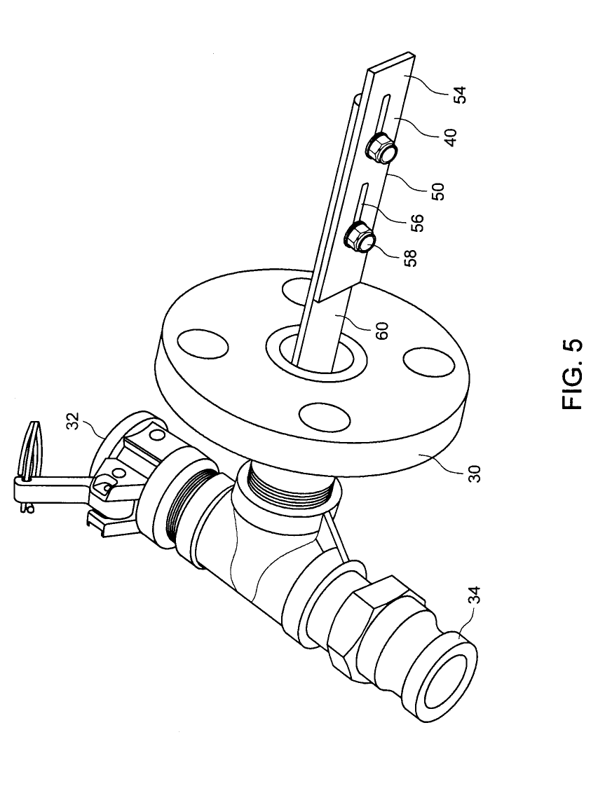

The chemical supply line 28 attaches to a first combustion can 10 using a cleaning flange 30 that is connected to the quaternary fuel flange 20. The cleaning flange 30 has a flange inlet 32 that has an adapter that receives the chemical solution supply line 28. The cleaning flange 30 also has a flange outlet 34 that has an adapter that connects to a cleaning solution transport line 36. As illustrated in the schematic of FIG. 4, the cleaning flange 30 has a flow directing baffle 40 that enters the quaternary fuel inlet orifice 14 and extends the length of a throat 42 leading from the quaternary fuel flange 20 to the quaternary annulus chamber 16. The flow directing baffle 40 divides the throat 42 into a cleaning solution inlet portion 44 and a cleaning solution outlet portion 46. Cleaning solution flows from the pump 26 into the flange inlet 32 and quaternary fuel inlet orifice 14 and through the inlet portion 44 of the throat 42 as seen by flow indicating arrows I. In the illustrated embodiment, once the cleaning solution enters the quaternary annulus chamber 16, the baffle 40 directs the flow in a clockwise direction in the quaternary annulus chamber 16 around the circumference of the forward combustion can 10 as seen by flow indicating arrows A. Upon navigating around the quaternary annulus chamber 16, the cleaning solution flow is directed by the baffle 40 into the outlet portion 46 of the throat 42 and out of the combustion can 10 through the flange outlet 34 as seen by flow indicating arrows O. As best seen in the perspective view of FIG. 5, the baffle 40 of the cleaning flange 30 has a baffle extension means 50 used to vary the length of the baffle 40 such that it makes contact with an inner wall surface 52 of the quaternary annulus chamber 16 when the cleaning flange 30 is installed on the quaternary fuel flange 20. In one embodiment, the baffle extension means 50 includes a slideable baffle plate 54 containing one or more slots 56 configured to receive nuts 58 used to provide a frictional connection to a non-slideable baffle plate 60. However, one skilled in the art will understand that other baffle extension means 50 may be used using sound engineering judgment.

In one embodiment, multiple combustion cans 10 of one or more gas turbines may be connected in the chemical cleaning system 22. In one embodiment, multiple combustion cans 10 are connected in series such that cleaning solution flows out of the first can 10 is directed to a second and then through the remaining combustion cans 10 as depicted in FIG. 3. One skilled in the art will also understand that one or more of the combustion cans 10 may also be aligned in parallel. After the cleaning solution passes through the combustion cans 10, it is returned to the chemical supply reservoir 24.

The cleaning solution composition contains an iron dissolving agent. In one embodiment, the composition includes a phosphonate or phosphonic acid as a primary descalant and iron-dissolving agent. Additionally, the composition desirably contains a reducing agent, and an anticorrosion agent. Optionally, the composition may also include a surfactant or wetting agent and/or a dispersant. Suitable compositions are taught in commonly-owned U.S. Pat. No. 4,810,405 which is hereby incorporated by reference in its entirety. In one embodiment, the phosphonic acid is suitably hydroxyethylidene-diphosphonic acid (HEDP); the reducing agent is suitably isoascorbic acid, sodium sulfite, or mixtures thereof; and the anticorrosion agent is suitably benzotriazole; the surfactant or wetting agent is suitably an amphocarboxylate; and the dispersant is suitably a polyacrylate.

In one desirable embodiment, the cleaning solution composition includes CleanBlade™ GTC 1002 available from GE Water & Process Technologies of Trevose, Pa. CleanBlade™ GTC 1002 comprises Ferroquest® FQ7101 and Ferroquest® FQ7102, also available from GE Water & Process Technologies. FQ7101 contains phosphonic acid (HEDP) in the range of 7 to 13 w/w %. FQ7102 contains HEPD in the range of 10 to 20 w/w %, formic acid in the range of 7 to 13 w/w %, and Glycolic acid in the range of 1 to 5 w/w %. The FQ7101 is the main cleaning product and the FQ7102 is the neutralizing material. It is desirable that the cleaning solution composition maximize the rate of rust removal while at the same time minimizing corrosion to the base metal. Unfortunately, these two aims are mutually exclusive in practice, since in the general case rust is removed by a process that inherently results in some corrosion. Realistically, therefore the best descalants aim at providing efficient cleaning while keeping corrosion within acceptable limits. With the FQ7101/FQ7102, it has been determined that maintaining the pH in the range of range 5.0-5.5 has provided more rapid results for cleaning than if the pH were maintained in the higher range of 6.3-7.2. It has been determined that maintaining the pH in the range of 5.0 to 5.5 typically provides adequate cleaning of the quaternary annulus chamber 16 in about 3 to 5 days. The corrosion rate for carbon steel coupons in the chemical supply reservoir 24 has been determined to be in the range of 5 to 10 Mils per Year (MPY) at the average pH of 5.3. By comparison, an inhibited acid cleaning solution will average about 500 MPY. In addition, the CleanBlade™ cleaning solution composition provides a passive phosphate based protective film on the cleaned surfaces.

The chemical supply reservoir 24 is initially filled with water. In one embodiment, the chemical supply reservoir 24 is filled with 80 gallons of water which is allowed to circulate in the chemical cleaning system 22 to flush the quaternary annulus chambers 16 being cleaned by the system 22. Twenty gallons of CleanBlade™ GTC 1002 is then added to the chemical supply reservoir 24 to obtain a 20% solution. However, one skilled in the art will understand that different amounts of water and CleanBlade™ may be used without departing from the scope of the invention. Ferroquest® FQ7102 is then added to the solution until the pH is between 5.0 and 7.0, and more desirably between 5.0 and 5.5. The pH is monitored periodically, for example every 3 hours. In one embodiment, if the pH is above 5.5, FQ7102 is added to the cleaning solution in the chemical supply reservoir 24 until the pH is between 5.0 and 5.5. The temperature of the cleaning solution is monitored periodically and desirably maintained in the range of between about 80° F. and about 140° F., and more desirably range of between about 100° F. and about 120° F. with a target temperature of 120° F. Temperature may be maintained with heaters 70 in the chemical supply reservoir 24 and with insulating covers wrapped (not shown) around the combustion cans 10.

The iron level in the cleaning solution is periodically monitored. Suitable monitoring intervals include every 12 to 24 hours. CleanBlade™ GTC 1002 can hold 10,000 ppm of iron in solution as Fe₂O₃. If the iron levels exceed 9000 ppm, the system should be flushed such as by draining 25 gallons of the solution and then adding 20 gallons of water and 5 gallons of the CleanBlade GTC 1002.

Desirably, after the cleaning solution has been circulated in the chemical cleaning system 22 for a period of time, such as 24 hours, each combustion can 10 should be reconnected such that the direction of flow through the quaternary annulus chamber 16 of each can 10 is reversed.

The cleaning solution is desirably circulated the chemical cleaning system 22 for between 48 hours and 120 hours. However, one skilled in the art will understand that longer or shorter times may be used based on the level of corrosion and initial iron deposits present in the quaternary annulus chamber 16. Generally, cleaning is conducted at a more rapid rate at higher temperatures and at a lower pH.

After a designated period of time, the quaternary annulus chambers 16 are flushed with fresh water and high pressure air to clean out remaining residue. A boroscope is desirably used to inspect each unit. If unsatisfactory levels of iron deposits remain in the combustion cans 10, circulation of cleaning solution is reinitiated in the chemical cleaning system 22, desirably for at least an additional 12 hours.

Thus, the invention works by creating a chemical cleaning system 22 having a pump circuit that allows circulation of the cleaning solution through the forward combustion can quaternary annulus chamber 16 using a cleaning flange 30 that directs the flow around the internal chamber 16. As an added benefit of this cleaning configuration, multiple combustion cans 10 can be joined together and cleaned all at the same time. In this manner, the set of 14 forward combustion cans 10 off one GE gas turbine can be joined together and cleaned during a single outage within a few days. The technical and commercial advantages of this invention are substantial in terms of reduced outage time for gas turbine operators. Another advantage is the near neutral pH of the cleaning solution allows for discharge of the solution through standard methods.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A method of cleaning iron oxide corrosion deposits that have accumulated in quaternary fuel gas distribution annulus chambers in forward combustion cans of a gas turbine, wherein each forward combustion can has a quaternary fuel flange and a quaternary fuel inlet orifice leading to the quaternary annulus chamber, the method comprising:
attaching a cleaning flange to the quaternary fuel flange of at least one forward combustion can, wherein the cleaning flange has a flow directing baffle that enters the quaternary fuel inlet orifice and extends the length of a throat leading from the quaternary fuel flange to the quaternary annulus chamber such that the baffle divides the throat into a cleaning solution inlet portion and a cleaning solution outlet portion;
connecting the can to a chemical cleaning system comprising a chemical supply reservoir that functions as a sump for the cleaning solution and a circulating pump taking suction from the supply reservoir;
filling the chemical cleaning system with a cleaning solution having a composition containing an iron dissolving agent;
directing the flow of cleaning solution into quaternary annulus chamber via the quaternary fuel flange using the cleaning flange and through the inlet portion of the throat such that the baffle directs the flow in one direction in the quaternary annulus chamber around the circumference of the can, wherein upon navigating around the quaternary annulus chamber, the baffle directs the cleaning solution into the outlet portion of the throat and out of the combustion can through the cleaning flange; and
returning the cleaning solution to the chemical supply reservoir.

2. The method of claim 1 further comprising removing the forward combustion can from the gas turbine before directing the flow of cleaning solution into the quaternary annulus chamber.

3. The method of claim 1 further comprising blowing down the quaternary annulus chambers using high pressure air to remove lose debris and flushing the quaternary annulus chambers with fresh water prior to circulating the cleaning solution.

4. The method of claim 1 wherein the cleaning flange has flange inlet that receives cleaning solution into the combustion can and a flange outlet directs cleaning solution out of the combustion can.

5. The method of claim 1 further comprising adjusting the length to the baffle of the cleaning flange with a baffle extension means such that the baffle makes contact with an inner wall surface of the quaternary annulus chamber.

6. The method of claim 1 further comprising simultaneously connecting multiple combustion cans of one or more gas turbines to the chemical cleaning system.

7. The method of claim 6 wherein at least two of the combustion cans are connected in series.

8. The method of claim 1 wherein the iron dissolving agent is a phosphonic acid.

9. The method of claim 8 wherein the iron dissolving agent is hydroxyethylidene-diphosphonic acid.

10. The method of claim 1 further comprising maintaining the pH of the cleaning solution between a pH of 5.0 and 5.5.

11. The method of claim 1 further comprising maintaining the temperature of the cleaning solution in the range of between about 100° F. and about 120° F.

12. The method of claim 1 further comprising maintaining the iron levels in the cleaning solution below 9000 ppm by periodically draining a portion of the solution and then adding water and cleaning solution.

13. The method of claim 1 further comprising periodically reversing the direction of flow through the quaternary annulus chamber.

14. The method of claim 1 further comprising circulating the cleaning solution in the chemical cleaning system for between 48 hours and 120 hours.

15. The method of claim 1 further comprising flushing the quaternary annulus chamber with fresh water and high pressure air after the cleaning solution has been circulated to remove remaining residue.

16. A method of cleaning iron oxide corrosion deposits that have accumulated in quaternary fuel gas distribution annulus chambers in a forward combustion cans of a gas turbine, wherein each forward combustion can has a quaternary fuel flange and a quaternary fuel inlet orifice leading to the quaternary annulus chamber, the method comprising:
removing a plurality of forward combustion cans from the gas turbine;
attaching a cleaning flange to the quaternary fuel flange of the cans, wherein the cleaning flange has a flow directing baffle that enters the quaternary fuel inlet orifice and extends the length of a throat leading from the quaternary fuel flange to the quaternary annulus chamber such that the baffle divides the throat into a cleaning solution inlet portion and a cleaning solution outlet portion;
connecting the cans to a chemical cleaning system comprising a chemical supply reservoir that functions as a sump for the cleaning solution and a circulating pump taking suction from the supply reservoir;
filling the chemical cleaning system with a cleaning solution having a composition containing an iron dissolving agent, wherein the cleaning solution comprises a phosphonic acid;
directing the flow of cleaning solution into quaternary annulus chambers of the plurality of forward combustion cans via the quaternary fuel flange using the cleaning flange and through the inlet portion of the throat such that the baffle directs the flow in one direction in the quaternary annulus chamber around the circumference of the can, wherein upon navigating around the quaternary annulus chamber, the baffle directs the cleaning solution into the outlet portion of the throat and out of the combustion can through the cleaning flange; and
returning the cleaning solution to the chemical supply reservoir.

17. The method of claim 16 further comprising maintaining the pH of the cleaning solution between a pH of 5.0 and 5.5.

18. The method of claim 16 further comprising maintaining the temperature of the cleaning solution in the range of between about 100° F. and about 120° F.

19. The method of claim 16 further comprising maintaining the iron levels in the cleaning solution below 9000 ppm by periodically draining a portion of the solution and then adding water and cleaning solution.
